(19) United States
(12) Patent Application Publication
(10) Pub. No.: US 2007/0005813 A1
(43) Pub. Date: Jan. 4, 2007

(54) PERIPHERAL DEVICE AND METHOD FOR INTERPRETING REDEFINED FRAME INFORMATION STRUCTURE

(76) Inventors: Jih-Liang Juang, I-Lan Hsien (TW); Pao-Ching Tseng, Hsinchu County (TW); Jeng-Horng Tsai, Kao-Hsiung City (TW)

Correspondence Address: NORTH AMERICA INTELLECTUAL PROPERTY CORPORATION, P.O. BOX 506, MERRIFIELD, VA, 22116, US

(21) Appl. No.: 11/306,902

(22) Filed: Jan. 16, 2006

Related U.S. Application Data
(60) Provisional application No. 60/595,423, filed on Jul. 4, 2005.

(51) Int. Cl. G06F 3/00

(52) U.S. Cl. 710/1

(57) ABSTRACT

A peripheral device for receiving a data frame containing control information from a serial transmission channel is disclosed. The peripheral device includes an information interpreter and a control unit. The information interpreter is coupled to the serial transmission channel, and used for receiving the data frame and interpreting the data frame to generate an operation signal according to the control information. The control unit is coupled to the information interpreter, and used for receiving the operation signal to execute an operation according to the control information.

### CROSS REFERENCE TO RELATED APPLICATIONS

The application claims the benefit of U.S. Provisional Application No. 60/595,423, which was filed on Jul. 4, 2005 and is included herein by reference.

### BACKGROUND OF THE INVENTION

The invention relates to a peripheral device and a method for interpreting a redefined frame information structure (FIS) transmitted from a serial advanced technology attachment (SATA) interface.

SATA specifications are applied to a transmission interface between a host and a peripheral device such as a hard disk drive or an optical disc drive. These specifications are going to replace an advanced technology attachment (ATA) specification. SATA specifications define two pairs of differential signals to replace conventional forty or eighty parallelized signals. SATA specifications reduce a circuit size, lower operation voltages, and increase a transmission rate by serializing the transmitted data. SATA specifications also include some new functions such as flow control and retransmission to facilitate simple control on a data stream.

Firmware is required for a hard disk drive or an optical disc drive to operate normally. The firmware is stored in a non-volatile memory (usually, a flash memory is used) for a SATA complied disc drive. In related art, a read-only memory (ROM) writer is commonly used to first write the firmware (i.e., program codes) into the non-volatile memory. Then, the non-volatile memory is installed on a circuit board of the hard disk drive or the optical disc drive. However, this procedure requires a lot of time and increases production costs. A significant amount of time and money would be saved if it were possible to write the firmware through a SATA differential channel during the mass production operation.

In a SATA complied interface, commands or data transmitted between a host and a device must use a frame information structure (FIS). That is to say, if one plans to access firmware (no matter to write or to read firmware), some fields in a FIS structure must be redefined in order to carry memory access commands or firmware information. In related art, firmware updating is performed with the help of a microprocessor, and this will increase the loads of the microprocessor. Therefore, in order to improve the firmware updating performance and simplify the firmware updating procedure, a mechanism capable of accessing a non-volatile memory, which is used to store firmware, without utilizing a microprocessor is needed.

Besides the firmware updating, the microprocessor still has to process many other operations. The performance of the firmware updating is degraded due to the limited computing power of the microprocessor. Therefore, a novel design capable of alleviating loading of the microprocessor is beneficial to improving the overall performance of the peripheral device.

### SUMMARY

It is therefore one of the objectives of the claimed invention to provide a peripheral device having an information interpreter and a control unit to alleviate loading of the microprocessor, thereby boosting the performance of firmware updating.

The claimed invention discloses a peripheral device for receiving a data frame containing control information from a serial transmission channel. The peripheral device includes an information interpreter and a control unit. The information interpreter is coupled to the serial transmission channel, and used for receiving the data frame and interpreting the data frame to generate an operation signal according to the control information. The control unit is coupled to the information interpreter, and used for receiving the operation signal to execute an operation according to the control information.

In addition, the claimed invention discloses a method for receiving a data frame containing control information from a serial transmission channel. The method includes receiving the data frame and interpreting the data frame to generate an operation signal according to the control information; and receiving the operation signal to execute an operation according to the control information.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of an optical disc drive according to a first embodiment of the present invention.

FIG. 2 is a table illustrating the definition and size of the four arguments of a memory access command according to one embodiment of the present invention.

FIG. 3 is a host-to-device register FIS structure according to SATA standards.

FIG. 4 is a redefined host-to-device register FIS structure utilized to carry a memory access command according to one embodiment the present invention.

FIG. 5 is a redefined host-to-device register FIS structure utilized to carry a transferring data of a memory access command according to one embodiment the present invention.

FIG. 6 is a user-defined FIS structure utilized to carry memory access commands or transferring data according to one embodiment of the present invention.

FIG. 7 is an interactive diagram illustrating a writing procedure of the optical disc drive shown in FIG. 1.

FIG. 8 is an interactive diagram illustrating a reading procedure of the optical disc drive shown in FIG. 1.

FIG. 9 is an interactive diagram illustrating a writing procedure of the optical disc drive shown in FIG. 1 by using a predefined ATAPI command.

FIG. 10 is an interactive diagram illustrating a reading procedure of the optical disc drive 120 shown in FIG. 1 by using a predefined ATAPI command.

### DETAILED DESCRIPTION

Please note that, for simplicity, a host and a peripheral device provided below in any embodiment are serial advanced technology attachment (SATA) standards compliant apparatus. Further, an optical disc drive is adopted here as an example of the peripheral device. However, these are not meant to be limitations of the present invention. The present invention is capable of being applied to any serial transmission interface between a host and a peripheral device, such as SATA or SAS, for interpreting the redefined information.

According to the above descriptions, the data frame should be specified to a Frame Information Structure (FIS), and the information interpreter should be specified to a FIS interpreter for explaining the following embodiments. The following embodiments explain the operation of the firmware updating, but this should not limit the present invention to only executing this operation. After reading the following disclosure, those skilled in this art can realize that the present invention is capable of being applied to any operation between the host and the peripheral device.

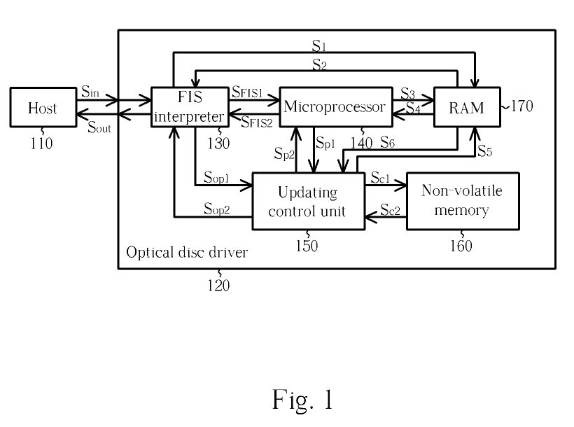

Please refer to FIG. 1. FIG. 1 is a block diagram of an optical disc drive 120 according to an embodiment of the present invention. As shown in FIG. 1, the optical disc drive 120 comprises a frame information structure (FIS) interpreter 130, a microprocessor 140, an updating control unit 150, a non-volatile memory 160 and a random access memory (RAM) 170. Additionally, the optical disc drive 120 is further coupled to a host 110 through a SATA cable. In this embodiment, the optical disc drive 120 does not yet have any firmware installed and the host 110 is attempting to write firmware of the optical disc drive 120 into the non-volatile memory 160 through a serial transmission channel between the host 110 and the optical disc drive 120. The serial transmission channel is, but not limited to, a SATA differential channel in the present embodiment. In another embodiment, the non-volatile memory 160 has firmware already and the host 110 attempts to update the firmware through the SATA differential channel. According to the disclosure of the present invention, a new scheme of accessing (reading or writing) the firmware in the non-volatile memory 160 is detailed as follows.

Generally speaking, the non-volatile memory 160 is controlled by memory access commands. During an accessing procedure of the non-volatile memory 160, the host 110 sends an input signal Sᵢₙ, which is a data frame, through the SATA differential channel to the FIS interpreter 130 for interpreting the input signal Sᵢₙ into an operation signal Sₒₚ₁ if the input signal Sᵢₙ carries a memory access command. However, if the input signal Sᵢₙ carries no memory access command, the FIS interpreter 130 simply bypasses the information from the input signal Sᵢₙ to the microprocessor 140 for further processing. Please note that the input signal could not only be bypassed to the microprocessor but also to another FIS interpreter for other purposes. In the present embodiment, a memory access command is sent from the host 110 to the FIS interpreter 130 by means of an FIS structure specified in the SATA standards. The FIS structure used to carry the memory access commands can be a host-to-device register FIS, a data FIS, or a user-defined FIS. The above-mentioned FIS types used to carry the memory access commands must be redefined so that some fields in an FIS structure can be used to carry the desired memory access commands. Please note that the above-mentioned FIS types are only for illustration and are not meant to be taken as limitations to the present invention. Other FIS types can be utilized to carry memory access commands, too, after being redefined. Further, the FIS interpreter 130 is capable of identifying whether a specific FIS structure transmitted by the input signal Sin contains a memory access command or not. If the specific FIS structure contains no memory access command, the FIS interpreter 130 bypasses the specific FIS structure. The bypassed signal is passed along to the microprocessor 140 or is passed to another FIS interpreter for other operations as mentioned above. On the other hand, if the specific FIS structure contains a memory access command, the FIS interpreter 130 extracts the memory access command from the specific FIS structure and generates the operation signal Sₒₚ₁ to the updating control unit 150.

In one embodiment of the memory access commands, 6 types of memory access commands are provided: READ, WRITE, ERASE, STATUS, IDENTIFY, OTHER. A READ type command is for reading data stored in the non-volatile memory 160. A WRITE type command is for writing data into the non-volatile memory 160. An ERASE type command is for erasing data stored in the non-volatile memory 160. A STATUS type command is for checking or changing the state of the non-volatile memory 160. An IDENTIFY type command is for requesting the type of the non-volatile memory 160. Please note, people skilled in the art should know that there are still a lot of other command types, not mentioned above, could be used for performing other operations on the non-volatile memory 160 besides the above-mentioned commands.

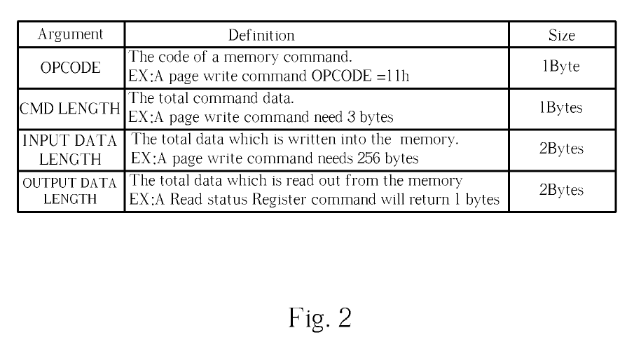

Each command type mentioned above contains several memory access commands. In every memory access command, four arguments can be extracted. Please refer to FIG. 2. FIG. 2 is a table illustrating the definition and size of the four arguments of a memory access command according to one embodiment of the present invention. As shown in FIG. 2, the four arguments are OPCODE, CMD LENGTH, INPUT DATA LENGTH, OUTPUT DATA LENGTH, respectively. The OPCODE is defined as a code corresponding to a memory access command. For example, a PAGE WRITE memory access command, belonging to a WRITE type command, has an OPCODE of 11 h in the present embodiment. The CMD LENGTH is defined as a length of a specific memory access command. For example, a PAGE WRITE memory access command, belonging to a WRITE type command, has 3-byte data. The INPUT DATA LENGTH is defined as a total amount of data to be written into the non-volatile memory 160. For example, a PAGE WRITE memory access command, belonging to a WRITE type command, writes 256-byte data into the non-volatile memory 160. The OUTPUT DATA LENGTH is defined as a total amount of data to be read out from the non-volatile memory 160. For example, a PAGE WRITE memory access command, belonging to a WRITE type command, writes 256-byte data into the non-volatile memory 160. Please note that the above-mentioned definitions of memory access commands are only for illustration and not meant to be taken as limitations of the present invention. Besides, the above-mentioned operation signal Sₒₚ₁ is generated according to the extracted arguments of memory access commands.

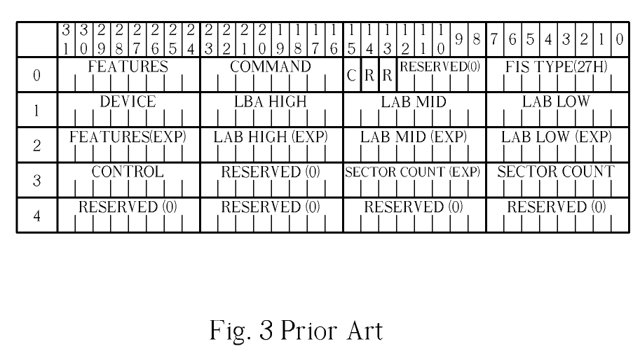

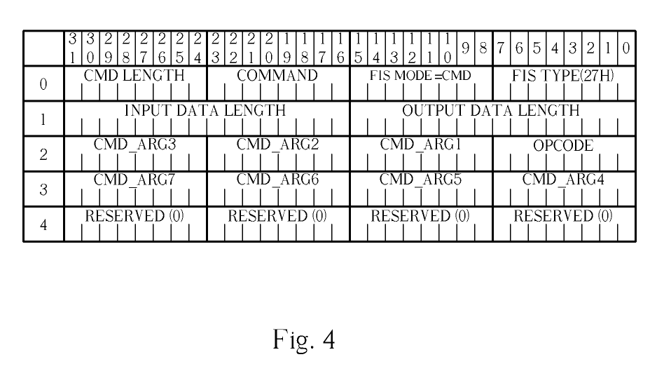

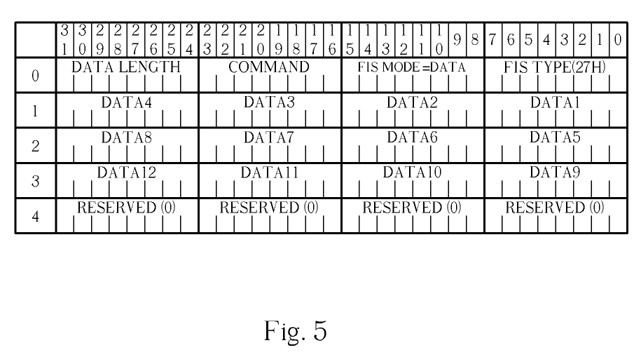

Please refer to FIG. 3 and FIG. 4 simultaneously. FIG. 3 is a host-to-device register FIS structure according to SATA standards and FIG. 4 is a redefined host-to-device register FIS structure utilized to carry a memory access command according to one embodiment of the present invention. As shown in FIG. 3 and FIG. 4, the host-to-device register FIS is redefined so as to carry a memory access command. In FIG. 4, a maximum of eight arguments of a memory access command can be carried in a redefined host-to-device register FIS structure (in the present example, only 4 arguments are used). A “FIS TYPE” field is reserved so that this redefined host-to-device register FIS structure still belongs to a host-to-device register FIS structure. Please note that there is a “FIS MODE=CMD” field. It is this field that is checked by the FIS interpreter 130 to tell whether an incoming host-to-device register FIS contains a memory access command or not. In addition, a host-to-device register FIS can also be redefined to carry the transferring data of a memory access command as shown in FIG. 5.

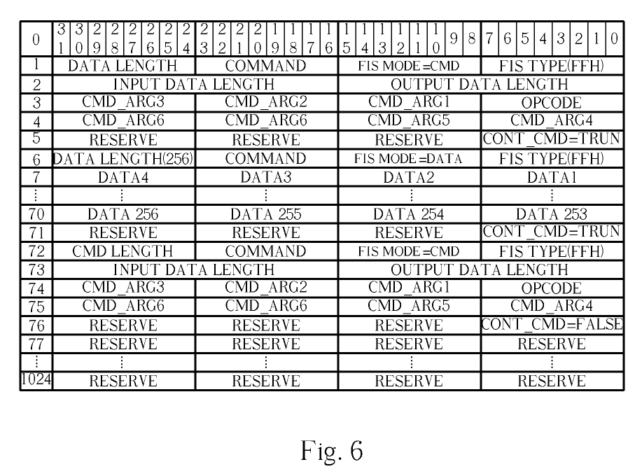

The redefined host-to-device register FIS structures mentioned above are only examples of redefining FIS structures so as to be used in carrying memory accessing commands or corresponding transferring data. People skilled in the art are able to redefine other kinds of FIS structures for the purpose of carrying memory access commands by FIS structures. Please refer to FIG. 6. FIG. 6 is a user-defined FIS structure defined for carrying memory access commands or transferring data according to one embodiment of the present invention. As shown in FIG. 6, this FIS structure combines a plurality of FISes into one user-defined FIS and is called a batch-type FIS. The “FIS TYPE” of the batch-type FIS is defined as “FFh” and the length of the batch-type FIS is 4096 bytes. From the 1^{st} double word (DWORD) to the 5^{th} DWORD, it is the first FIS and it is a command FIS as shown in FIG. 4. If the “CONT_CMD” field is “TRUE”, it means that the following bytes of the “CONT_CMD” field contain more information. On the other hand, if the “CONT_CMD” field is “FALSE”, it means that the rest bytes behind the “CONT_CMD” field are all reserved bytes only. From the 6^{th} DWORD to the 10^{th} DWORD, it is the second FIS and it is a data FIS as shown in FIG. 5. The FIS interpreter 130 can interpret the batch-type FIS into multiple command FISes or multiple data FISes by sequence.

The updating control unit 150 generates a control signal S_{c1} to perform operations on the non-volatile memory 160 according to the operation signal Sₒₚ₁. The non-volatile memory 160 operates according to the control signal S_{c1} and makes suitable responses corresponding to operations requested by the control signal S_{c2}. The responses of the non-volatile memory 160 are transmitted by a control signal S_{c2} and the control signal S_{c2} is further transmitted into the updating control unit 150. The updating control unit 150 translates the responses transmitted by the control signal S_{c2} and generates an operation signal Sₒₚ₂ to inform the FIS interpreter 130. According to the operation signal Sₒₚ₂, the FIS interpreter 130 fills responsive information in a FIS structure and then generates an output signal Sₒᵤₜ carrying the FIS structure to notify the host 110 about the responses of the non-volatile memory 160. Please note that a FIS structure chosen to transmit the responsive information of the non-volatile memory 160 to the host 110 can be any one of the following FIS types: a device-to-host register FIS, a data FIS, or a user-defined FIS. Additionally, the above-mentioned FIS types used to carry the responsive information to notify the host 110 must be redefined so that some fields of a FIS structure can be used to carry the responsive information. Please note that the above-mentioned FIS types are only for illustration and are not meant to be taken as limitation to the present invention. Other FIS structures can be utilizing to carry the responsive information, too, after being redefined.

In a writing procedure of the non-volatile memory 160, the updating information, or called data segments, of the firmware are transmitted from the host 110 to the FIS interpreter 130 by the input signal Sᵢₙ. Therefore, not only a memory access command, but also the updating information (data segments) of firmware are carried on a FIS structure. A FIS structure used to carry the memory access commands (as mentioned above, a host-to-device register FIS, a data FIS, or a user-defined FIS) can also be used to carry the data segments of the firmware. In one embodiment, a host-to-device register FIS structure (as above-mentioned data FIS shown in FIG. 5) is adopted to carry the data segments of the firmware from the host 110 to the FIS interpreter 130. For each host-to-device register FIS, a 1-byte data is carried in the present embodiment and the FIS interpreter 130 extracts the 1-byte data from each host-to-device register FIS and sends the 1-byte data to the RAM 170 for buffering the 1-byte data through a first signal S₁. When the buffered data achieves a predetermined amount (e.g., a page of 256 bytes), the updating control unit 150 retrieves the buffered data from the RAM 170 through a sixth signal S₆ and writes the buffered data into the non-volatile memory 160 through the control signal S_{c1}. Though the firmware and the microprocessor 140 are not utilized, the data writing of the non-volatile memory 160 is correctly controlled through the FIS interpreter 130. Please note the RAM is not essential for an updating control unit. For some non-volatile memory, buffer behavior is needless.

Alternatively, in a reading procedure, data segments of firmware are read from the non-volatile memory 160 through the control signal S_{c2} and buffered in the RAM 170 through a fifth signal S₅ outputted from the updating control unit 150. When the buffered data achieves a predetermined amount (e.g., a page of 256 bytes), the FIS interpreter 130 retrieves the buffered data from the RAM 170 through a second signal S₂ and sends the retrieved data to the host 110 through FIS structures transmitted via the output signal Sₒᵤₜ. A FIS structure chosen to transmit the responsive information of the non-volatile memory 160 to the host 110 (as mentioned above, a device-to-host register FIS, a data FIS, or a user-defined FIS) can also be used to carry the data segments of the firmware. In one embodiment, a device-to-host register FIS is utilized to carry the data segments of the firmware from the FIS interpreter 130 to the host 110 and a 1-byte data is carried for each device-to-host register FIS. Before the updating control unit 150 begins reading data segments of the firmware, again from the non-volatile memory 160, all the data segments buffered in the RAM 170 are retrieved and sent to the host 110 via a plurality of device-to-host register FISes. Though the firmware and the microprocessor 140 are not utilized, the data reading of the non-volatile memory 160 is correctly controlled through the FIS interpreter 130.

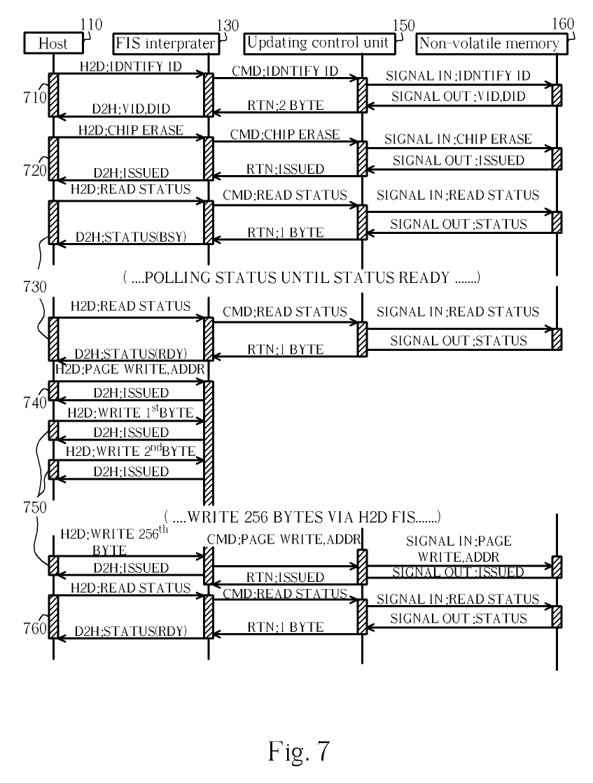

Please refer to FIG. 7. FIG. 7 is an interactive diagram illustrating a writing procedure of the above-mentioned optical disc drive 120 shown in FIG. 1. The non-volatile memory 160 already contains firmware in the present embodiment and the writing procedure is activated to update the existing firmware. Please note that the present invention is not limited to the above-mentioned conditions. That is, even there is no firmware in the non-volatile memory 160, the write procedure can still function normally. Each step of the writing procedure is detailed as follows.

Step 710:

1. The host 110 makes use of a host-to-device register FIS to carry an “IDENTIFY” command to the FIS interpreter 130 for checking a type of the non-volatile memory 160.

2. The FIS interpreter 130 detects that the host-to-device register FIS contains the “identify” command and then interprets the “IDENTIFY” command into an “executable IDENTIFY” command executable to the updating control unit 150.

3. The updating control unit 150 executes the “executable IDENTIFY” command received from the FIS interpreter 130 to retrieve vendor ID (VID) and device ID (DID) information from the non-volatile memory 160, and the returns VID data and DID data to the FIS interpreter 130.

4. The FIS interpreter 130 uses a device-to-host register FIS to carry the VID and DID data provided by the updating control unit 150 to the host 110.

Step 720:

1. The host 110 uses a host-to-device register FIS to carry a “CHIP ERASE” command to the FIS interpreter 130 for erasing the existing firmware in the non-volatile memory 160.

2. The FIS interpreter 130 detects that the host-to-device register FIS contains the “chip erase” command and then interprets the “CHIP ERASE” command into an “executable CHIP ERASE” command executable to the updating control unit 150.

3. The updating control unit 150 executes the “executable CHIP ERASE” command.

4. The FIS interpreter 130 uses a device-to-host register FIS to carry a command issued information (“ISSUED”) to the host 110.

Step 730:

1. The host 110 uses a host-to-device register FIS to carry a “READ STATUS” command to the FIS interpreter 130 for checking if the “CHIP ERASE” command is finished.

2. The FIS interpreter 130 detects that the host-to-device register FIS contains the “READ STATUS” command and then interprets the “READ STATUS” command into an “executable READ STATUS” command executable to the updating control unit 150.

3. The updating control unit 150 executes the “executable READ STATUS” command to check a current status of the non-volatile memory 160 and then returns a status information (“BSY”) to the FIS interpreter 130 if the non-volatile memory 160 is not completely erased yet.

4. The FIS interpreter 130 uses a device-to-host register FIS to carry a status information (“status(BSY)”) provided by the updating control unit 150 to the host 110.

5. The host 110 receives the status information (“status(BSY)”) and continues polling a status of the non-volatile memory 160 by issuing the “READ STATUS” command.

6. The FIS interpreter 130 uses a device-to-host register FIS to carry a status information (“status(RDY)”) to inform the host 110 the “chip erase” command is finished.

Step 740:

1. The host 110 uses a host-to-device register FIS to carry a “PAGE WRITE” command and address information (“ADDR”) to the FIS interpreter 130 for requesting the FIS interpreter 130 to active a writing procedure of the non-volatile memory 160.

2. The FIS interpreter 130 uses a device-to-host register FIS to carry an “ISSUED” information to the host 110 to notify the host 110.

Step 750:

1. The host 110 uses a host-to-device register FIS to carry a 1-byte data to the FIS interpreter 130.

2. The FIS interpreter 130 buffers the received 1-byte data into the RAM 170 and uses a device-to-host register FIS to carry an “ISSUED” information to notify the host 110.

3. The host 110 continues transmitting a plurality of 1-byte data until an amount of buffered data reaches a predetermined value, such as, one page of 256 bytes.

4. The FIS interpreter 130 interprets the “PAGE WRITE” command into an “executable PAGE WRITE” command executable to the updating control unit 150.

5. The updating control unit 150 retrieves the buffered data from the RAM 170, executes the “executable PAGE WRITE” command to write the retrieved buffered data into the non-volatile memory 160 according to the above-mentioned address information (“ADDR”), and returns an “ISSUED” information to the FIS interpreter 130.

6. The FIS interpreter 130 uses a device-to-host register FIS to carry an “ISSUED” information to inform the host 110.

Step 760:

1. The host 110 uses host-to-device register FIS to carry a “READ STATUS” command to the FIS interpreter 130 for checking if the “PAGE WRITE” command is finished.

2. The FIS interpreter 130 detects that the host-to-device register FIS contains the “READ STATUS” command and then interprets the “READ STATUS” command into an “executable READ STATUS” command executable to the updating control unit 150.

3. The updating control unit 150 executes the “executable READ STATUS” command to checking a current status of the non-volatile memory 160, and returns a status information (“RDY”) to the FIS interpreter 130 if the page writing operation is done.

4. The FIS interpreter 130 uses a device-to-host register FIS to carry a status information (“status(RDY)”) to inform the host 110 the “PAGE WRITE” command is finished. Then, go back to Step 740 for page writing remaining data segments of the firmware until all data segments of firmware are written into the non-volatile memory 160.

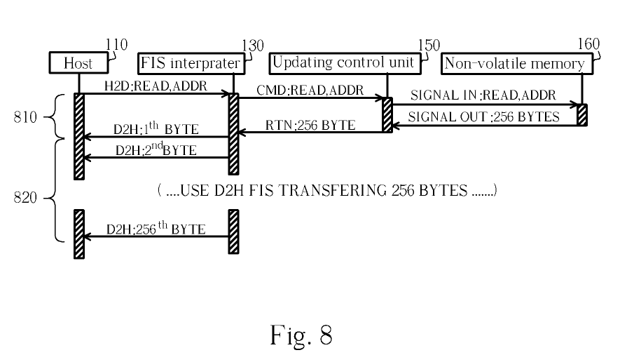

Please refer to FIG. 8. FIG. 8 is an interactive diagram illustrating a reading procedure of the above-mentioned optical disc drive 120 shown in FIG. 1. Please note that the non-volatile memory 160 already contains part of or an entire complete firmware in the present embodiment and the reading procedure is activated to read one page of the firmware (256 bytes) from the non-volatile memory 160 to the host 110. Each step of the reading procedure is detailed as follows.

Step 810:

1. The host 110 uses a host-to-device register FIS to carry a “READ” command and address information (“ADDR”) to the FIS interpreter 130 for requesting the FIS interpreter 130 to active a reading procedure of the non-volatile memory 160.

2. The FIS interpreter 130 detects that the host-to-device register FIS contains the “READ” command and then interprets the “READ” command into an “executable READ” command executable to the updating control unit 150.

3. The updating control unit 150 executes the “executable READ” command and buffers a page of firmware data (256 bytes) in the RAM 170 read from the non-volatile memory 160.

Step 820:

1. The FIS interpreter 130 retrieves the buffered firmware data from the RAM 170 and uses a device-to-host register FIS to carry 1 byte of buffered firmware data to the host 110.

2. The FIS interpreter 130 continues retrieving the buffered firmware data from the RAM 170 using consecutive device-to-host register FISes until all the buffered firmware data has been sent to the host 110.

SATA standards support both advanced technology attachment (ATA) and advanced technology attachment packet interface (ATAPI) commands. In ATAPI protocols under SATA standards, unlike ATAPI protocols under parallel advanced technology attachment (PATA) standards, a host uses FISes, instead of TASKFILE registers, to carry an ATAPI command. The first step of ATAPI command protocols under SATA standards is a host sending a host-to-device register FIS with a value of 0×A0 in a “COMMAND” field. Then, an ATAPI complied device should issue a PIOSetup FIS to inform the host that the ATAPI complied device is ready to receive a 12-byte ATAPI command. After recceivng a PIOSetup FIS, the host should issue a 12-byte Data FIS that contains the 12-byte ATAPI command. In previous arts, this handshaking should have a microprocessor of the ATAPI protocols complied device involved. Therefore, if there is no firmware in the ATAPI complied device, this ATAPI protocols cannot work.

The present invention can solve this problem. Please refer to FIG. 1 again. The FIS interpreter 130 can support receiving an ATAPI command from a host 110. If a “COMMAND” field of a host-to-device register FIS carries a value of 0×A0, the FIS interpreter 130 can automatically send a PIO Setup FIS back and wait for the following 12-byte ATAPI command sent from the host 110. If the following 12-byte ATAPI command carries memory access commands, the FIS interpreter takes operations requested by the 12-byte ATAPI command to access the non-volatile memory 160. On the other hand, if the following 12-byte ATAPI command carries no memory access command, the FIS interpreter bypasses the 12-byte ATAPI command simply passing it along to the microprocessor 140.

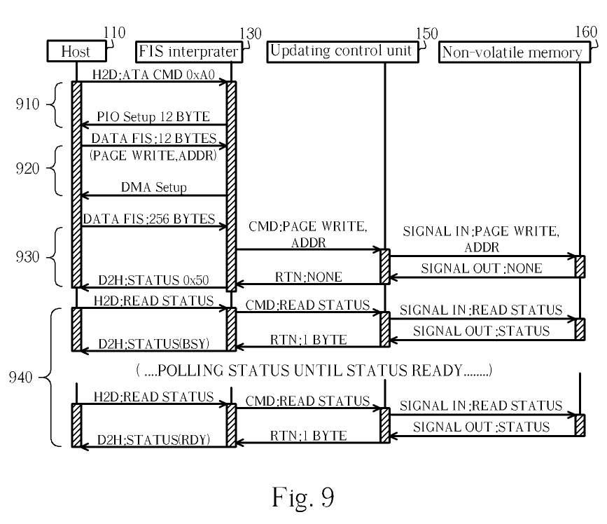

Please refer to FIG. 9. FIG. 9 is an interactive diagram illustrating an ATAPI mode writing procedure of the above-mentioned optical disc drive 120 shown in FIG. 1. The non-volatile memory 160 contains no firmware in the present embodiment and the writing procedure writes the firmware. Please note that the present invention is not limited to the above-mentioned conditions. That is, even there is firmware in the non-volatile memory 160, the write procedure can still function normally. Each step of the writing procedure is detailed as follows.

Step 910:

1. The host 110 issues a host-to-device register FIS carrying a value in “COMMAND” field equal to “0×A0” to the FIS interpreter 130.

2. The FIS interpreter 130 identifies the host 110 being willing to issue an ATAPI command, and the FIS interpreter 130 replies with a PIO Setup FIS and requests 12 bytes of ATAPI command.

Step 920:

1. The host 110 utilizes a data FIS to send the 12-byte ATAPI command to the FIS interpreter 130, and the 12-byte ATAPI command contains a “PAGE WRITE” command and address information (“ADDR”).

2. The FIS interpreter 130 issues a DMA Setup FIS to request 256-byte data transferred under a DMA transfer mode. Please note that the FIS interpreter 130 can also issue a PIO Setup FIS for requesting data from the host 110 when a PIO transfer mode instead of a DMA mode is requested.

Step 930:

1. The host 110 sends 256-byte data using a data FIS to the FIS interpreter 130.

2. The FIS interpreter 130 receives and buffers the 256-byte data in the RAM 170, and interprets the “PAGE WRITE” command to an “executable PAGE WRITE” command executable to the updating control unit 150.

3. The updating control unit 150 retrieves the buffered 256-byte data from the RAM 170 and performs the “executable PAGE WRITE” command on the non-volatile memory 160 to write the buffered 256-byte data into the non-volatile memory 160.

4. The updating control unit 150 replies a “none” information to inform the FIS interpreter 130.

5. The FIS interpreter 130 replies a status value of 0×50 utilizing a device-to-host register FIS to notify the host 110 that the ATAPI command has been performed.

Step 940:

1. The host 110 uses a host-to-device register FIS to carry a “READ STATUS” command to the FIS interpreter 130 for checking if the “PAGE WRITE” command is finished.

2. The FIS interpreter 130 detects that the host-to-device register FIS contains the “READ STATUS” command and then interprets the “READ STATUS” command into an “executable READ STATUS” command executable to the updating control unit 150.

3. The updating control unit 150 executes the “executable READ STATUS” command and returns a status information (“BSY”) to the FIS interpreter 130.

4. The FIS interpreter 130 uses a device-to-host register FIS to carry a status information (“status(BSY)”) to inform the host 110 the “PAGE WRITE” command is not finished yet.

5. The host 110 consecutively uses a host-to-device register FISes to carry a “READ STATUS” command to the FIS interpreter 130 for polling the page-writing status until a status information (“status(RDY)”) is received from the FIS interpreter 130.

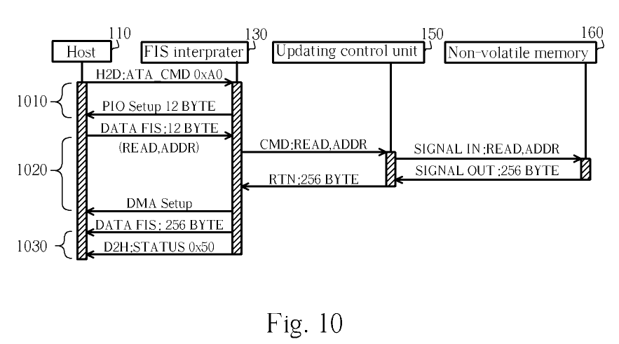

Please refer to FIG. 10. FIG. 10 is an interactive diagram illustrating an ATAPI reading procedure of the above-mentioned optical disc drive 120 shown in FIG. 1. Please note that the non-volatile memory 160 already contains part of or entire firmware in the present embodiment and the reading procedure reads one page of the firmware (256 bytes) from the non-volatile memory 160 to the host 110. Each step of the writing procedure is detailed as follows.

Step 1010:

1. The host 110 issues a host-to-device register FIS carrying a value in “COMMAND” field equal to 0×A0 to the FIS interpreter 130.

2. The FIS interpreter 130 identifies that the host 110 being willing to issue an ATAPI command, and replies a PIO Setup FIS spontaneously and requests 12-byte ATAPI command.

Step 1020:

1. The host 110 utilizes a data FIS to send the 12-byte ATAPI command to the FIS interpreter 130, and the 12-byte ATAPI command contains a “READ” command and address information (“ADDR”).

2. The FIS interpreter 130 interprets the “READ” command to an “executable READ” command executable to the updating control unit 150.

3. The updating control unit 150 executes the “executable READ” command and buffers a page of firmware data (256 bytes) in the RAM 170 read from the non-volatile memory 160 according to the address information (“ADDR”).

4. The FIS interpreter 130 issues a DMA Setup FIS to the host 110 for transferring data to the host 110 under a DMA transfer mode. Please note that the FIS interpreter 130 can also issue a PIO Setup FIS for transferring data to the host 110 when a PIO transfer mode instead of a DMA mode is requested.

Step 1030:

1. The FIS interpreter 130 retrieves the buffered data from the RAM 170 and uses a data FIS to carry the 256-byte firmware data to the host 110.

2. The FIS interpreter 130 replies a status value of 0×50 utilizing a device-to-host register FIS to notify the host 110 that the ATAPI commands have been performed.

The present invention redefines some FIS types specified in the SATA standards. This redefinition facilitates the SATA interface to be used to write or update a non-volatile memory of an SATA compliant device. Specifically, with the support of a FIS interpreter and an updating control unit mentioned above, an application layer program of a host does not require any modifications when the device changes its non-volatile memory. This saves the software developer a significant amount of time. Further, with the support of the FIS interpreter, a pre-defined ATAPI command can be used to access the non-volatile memory regardless of the functionality of the device's microprocessor. Moreover, the FIS interpreter takes advantage of a data FIS to carry updating information. This greatly reduces the amount of handshaking needed between the host and the device. Therefore, the performance is better than a conventional advanced technology attachment (ATA) standard compliant interface when updating or writing data into a non-volatile memory.

Besides the firmware updating mentioned above, the present invention can be also executed to process many other operations. With the information interpreter and control unit implemented therein, the peripheral device can execute any operation according to the redefined information signal sent from the host. As a result, the performance of the peripheral device is greatly improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A peripheral device for receiving a data frame containing control information from a serial transmission channel, comprising:
an information interpreter, coupled to the serial transmission channel, for receiving the data frame and interpreting the data frame to generate an operation signal according to the control information; and
a control unit, coupled to the information interpreter, for receiving the operation signal to execute an operation according to the control information.

2. The peripheral device of claim 1, wherein the information interpreter bypasses the data frame when the information interpreter fails to interpret the data frame.

3. The peripheral device of claim 2 further comprising:
a microprocessor, coupled to the information interpreter and the control unit, for processing the data frame bypassed by the information interpreter.

4. The peripheral device of claim 1, further comprising:
a first memory, couple to the control unit;
wherein when the data frame comprises memory access commands, the control executes an operation related to the first memory according to one of the memory access commands.

5. The peripheral device of claim 4, wherein the data frame contains updating information and the control unit writes the updating information into the first memory.

6. The peripheral device of claim 5, the peripheral device further comprising:
a second memory, coupled to the information interpreter and the control unit, for buffering data segments outputted from the information interpreter, the control unit retrieving buffered data from the second memory to write the updating information into the first memory.

7. The peripheral device of claim 1, wherein the serial transmission channel complies with serial advanced technology attachment (SATA) standards.

8. The peripheral device of claim 7, wherein the data frame is a frame information structure (FIS), and the information interpreter is a FIS interpreter.

9. The peripheral device of claim 8, wherein the FIS is selected one from the group consisted of a host-to-device FIS, a data FIS, and a user-defined FIS.

10. The peripheral device of claim 8, wherein the FIS interpreter sends a FIS to notify the host of a state of executing the operation, and the FIS is selected from the group consisted of a host-to-device FIS, a data FIS, and a user-defined FIS.

11. The peripheral device of claim 8, wherein a host communicates with the FIS interpreter by means of an advanced technology attachment packet interface (ATAPI) mode.

12. A method for receiving a data frame containing control information from a serial transmission channel, comprising:
(a) receiving the data frame and interpreting the data frame to generate an operation signal according to the control information; and
(b) receiving the operation signal to execute an operation according to the control information.

13. The method of claim 12, wherein step (a) further comprises bypassing the data frame when interpreting the data frame fails.

14. The method of claim 13, further comprising:
utilizing a microprocessor to process the bypassed data frame.

15. The method of claim 12, further comprising providing a first memory, wherein step (b) further comprises:
when the data frame comprises memory access commands, executing an operation related to a first memory according to one of the memory access commands.

16. The method of claim 15, wherein the data frame contains updating information, and the method further comprises:
writing the updating information into the first memory.

17. The method of claim 16, further comprising:
utilizing a second memory for buffering data segments generated from interpreting the data frame;
retrieving buffered data from the second memory to write the updating information into the first memory.

18. The method of claim 12, wherein the serial transmission channel complies with serial advanced technology attachment (SATA) standards.

19. The method of claim 18, wherein the data frame is a frame information structure (FIS).

20. The method of claim 19, wherein the FIS is selected one from the group consisted of a host-to-device FIS, a data FIS, and a user-defined FIS.

21. The method of claim 19, further comprising:
sending a FIS to notify a host of a state of executing the operation, the FIS is selected one from the group consisted of a host-to-device FIS, a data FIS, and a user-defined FIS.

22. The method of claim 19, wherein the data frame is transmitted by means of an advanced technology attachment packet interface (ATAPI) mode.
